(19) United States
(12) Patent Application Publication
(10) Pub. No.: US 2020/0190838 A1
(43) Pub. Date: Jun. 18, 2020

(54) POOL CLEANSING SYSTEM AND WEARABLE DEVICES THEREOF

(71) Applicant: Richard Grant, Plano, TX (US)

(72) Inventor: Richard Grant, Plano, TX (US)

(21) Appl. No.: 16/223,988

(22) Filed: Dec. 18, 2018

(51) Int. Cl. E04H 4/16; A41D 19/00; A41D 19/015; A43B 3/00; B08B 1/00; B08B 1/04; B08B 13/00

(52) U.S. Cl. CPC E04H 4/1618; A41D 19/0024; A41D 19/01594; B08B 13/00; B08B 1/002; B08B 1/04; A43B 3/0005

(57) ABSTRACT

A pair of cleansing handwear, including a scrubbing surface to scrub a surface of a pool to remove at least one of settlement, dirt, fungus, mildew, mold, and dirt, and at least one fingerless portion, such that at least one of a user's fingers can grasp at least one of tiles, rocks, leaves, and dirt during cleaning of the pool.

### BACKGROUND

### 1. Field

The present general inventive concept relates generally to a cleansing system, and particularly, to a pool cleaning system.

### 2. Description of the Related Art

Pool maintenance can often be a lot of work. Pools can quickly accumulate a lot of dirt and debris from usage and/or exposure to the weather.

For pool owners and cleaners everywhere, traditional pool brushes aren't always efficient. Sometimes, people end up having to use the bottoms of their feet to remove grime in hard-to-reach areas of the pool tiles. On other occasions, people will use their hands to grab floating items in the pool.

Therefore, there is a need for a system of wearable cleaning devices to help clean a pool more efficiently.

### SUMMARY

The present general inventive concept provides a pool cleansing system and wearable devices thereof.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a pair of cleansing handwear, including a scrubbing surface to scrub a surface of a pool to remove at least one of settlement, dirt, fungus, mildew, mold, and dirt, and at least one fingerless portion, such that at least one of a user's fingers can grasp at least one of tiles, rocks, leaves, and dirt during cleaning of the pool.

The scrubbing surface may include at least one of a plurality of bristles, a bubbled surface having protrusions extending therefrom, a mesh, and a sponge.

The pair of cleansing handwear may further include a power button disposed on at least a portion of the pair of cleansing handwear, and a motor to activate the scrubbing surface, such that the scrubbing surface rotates in response to the user pressing the power button.

The foregoing and/or other features and utilities of the present general inventive concept may also be achieved by providing a pair of cleansing footwear, including a scrubbing surface to scrub a surface of a pool to remove at least one of settlement, dirt, fungus, mildew, mold, and dirt, and a foot receiving aperture to receive a user's foot.

The scrubbing surface may include at least one of a plurality of bristles, a bubbled surface having protrusions extending therefrom, a mesh, and a sponge.

The pair of cleansing footwear may further include a power button disposed on at least a portion of the pair of cleansing footwear, and a motor to activate the scrubbing surface, such that the scrubbing surface rotates in response to the user pressing the power button.

The foregoing and/or other features and utilities of the present general inventive concept may also be achieved by providing a pool cleansing system, including a pair of cleansing handwear, including a scrubbing surface to scrub a surface of a pool to remove at least one of settlement, dirt, fungus, mildew, mold, and dirt, and at least one fingerless portion, such that at least one of a user's fingers can grasp at least one of tiles, rocks, leaves, and dirt during cleaning of the pool, and a pair of cleansing footwear, comprising a scrubbing surface to scrub a surface of a pool to remove at least one of settlement, dirt, fungus, mildew, mold, and dirt, and a foot receiving aperture to receive a user's foot.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a bottom view of a pair of cleansing handwear, according to an exemplary embodiment of the present general inventive concept; and

FIG. 2 illustrates a side view of a pair of cleansing footwear, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

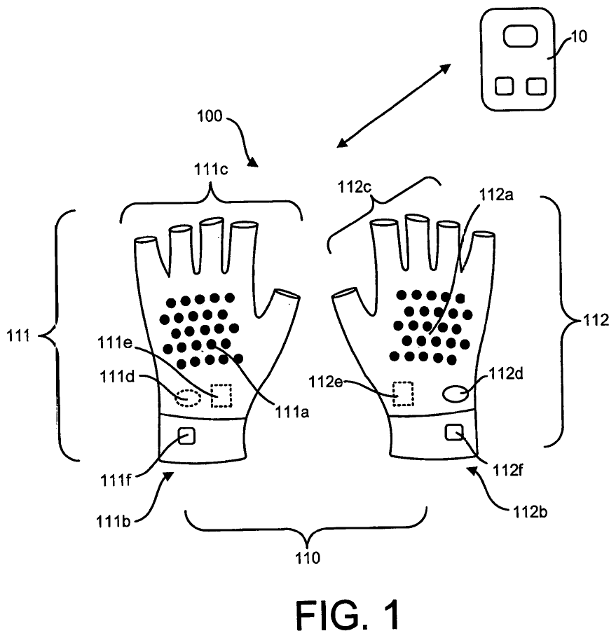

FIG. 1 illustrates a bottom view of a pair of cleansing handwear 110, according to an exemplary embodiment of the present general inventive concept.

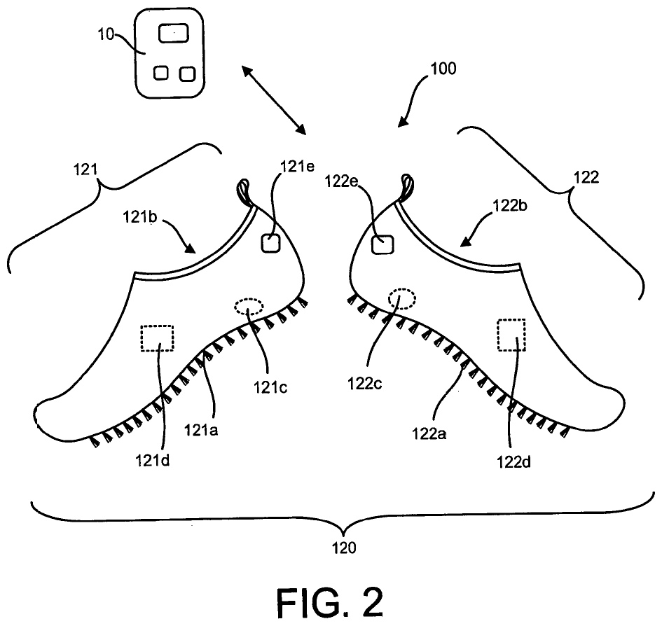

FIG. 2 illustrates a side view of a pair of cleansing footwear 120, according to an exemplary embodiment of the present general inventive concept.

The pool cleansing system 100 may be constructed from at least one of vinyl coated, vinyl coated synthetic fiber mesh, polyvinyl chloride (PVC), polyurethane coated waterproof ripstop nylon, canvas, duck cloth, neoprene, rubber, metal, and plastic, etc., but is not limited thereto. Moreover, the material may be quick drying after exposure to a liquid, such as pool water.

The pool cleansing system 100 may include the pair of cleansing handwear 110 and the pair of cleansing footwear 120, but is not limited thereto.

Referring to FIG. 1, the pair of cleansing handwear 110 is illustrated to be a pair of fingerless gloves. However, the pair of cleansing handwear 110 may be full-fingered gloves, mittens, a plastic handle to slide hands into that wraps between the pink any pointer finger, etc., but is not limited thereto. The pair of cleansing handwear 110 may be of any predetermined size, such as small, medium, large, and/or one size fits ail.

The pair of cleansing handwear 110 may include a first glove 111 and a second glove 112, but is not limited thereto.

The first glove 111 may include a scrubbing surface 111a, a hand receiving aperture 111b, at least one fingerless portion 111c, a motor 111d, a battery 111e, and a power button 111f, but is not limited thereto.

Referring to FIG. 1, the scrubbing surface 111a is illustrated to be disposed on at least a portion of a center of a bottom surface of the first glove 111. In other words, the scrubbing surface 111a may be disposed on a palm portion of the first glove 111. However, the scrubbing surface 111a may be disposed at any feasible location on the glove, such as finger portions and at least a portion of a top surface of the first glove 111.

The scrubbing surface 111a may include a plurality of bristles, a bubbled surface having protrusions extending therefrom, a mesh, and/or a sponge, etc., but is not limited thereto. The bristles may be short, long, hard, and/or soft, etc., but are not limited thereto. The scrubbing surface 111a may be applied against a portion of a surface in a pool needing to be cleansed. Specifically, the scrubbing surface 111a may be used to scrub the surface of the pool to remove settlement, fungus, mildew, mold, and/or dirt, etc., but is not limited thereto.

The hand receiving aperture 111b may receive a user's first hand therein in response to the user inserting the first hand inside the first glove 111. Moreover, the user's fingers may protrude from the at least one fingerless portion 111c. The at least one fingerless portion 111c may permit at least one of the user's fingers to grasp at least one of tiles, rocks, leaves, and dirt during cleaning of the pool.

The motor 111d may be disposed within at least a portion of the first glove 111. The power button 111f may be disposed on at least a portion of the first glove 111. Furthermore, the motor 111d may be enclosed in any waterproof material described above. The motor 111d may activate the scrubbing surface 111a, such that the scrubbing surface 111a may rotate and/or vibrate in response to the user pressing the power button 111f. Alternatively, the user may turn on the motor 111d using an external device 10, such as a mobile device, a computer, tablet, a personal digital assistant (PDA), etc., but is not limited thereto. Moreover, motor 111d receives power from the battery 111e.

The battery 111e may include lithium-ion, nickel cadmium, nickel metal hydride, alkaline, etc., but is not limited thereto. The battery 111e may be disposed within an enclosure constructed from any waterproof material described above. The battery 111e may be removed from the enclosure to be recharged.

The second glove 112 may include a scrubbing surface 112a, a hand receiving aperture 112b, at least one fingerless portion 112c, a motor 112d, a battery 112e, and a power button 112f, but is not limited thereto.

Referring to FIG. 1, the scrubbing surface 112a is illustrated to be disposed on at least a portion of a center of a bottom surface of the second glove 112. In other words, the scrubbing surface 112a may be disposed on a palm portion of the second glove 112. However, the scrubbing surface 112a may be disposed at any feasible location on the glove, such as finger portions and at least a portion of a top surface of the second glove 112.

The scrubbing surface 112a may include a plurality of bristles, a bubbled surface having protrusions extending therefrom, a mesh, and/or a sponge, etc., but is not limited thereto. The bristles may be short, long, hard, and/or soft, etc., but are not limited thereto. The scrubbing surface 112a may be applied against a portion of a surface in the pool needing to be cleansed. Specifically, the scrubbing surface 112a may be used to scrub the surface of the pool to remove settlement, fungus, mildew, mold, and/or dirt, etc., but is not limited thereto.

The hand receiving aperture 112b may receive the user's second hand therein in response to the user inserting the second hand inside the second glove 112. Moreover, the user's fingers may protrude from the at least one fingerless portion 112c. The at least one fingerless portion 112c may permit at least one of the user's fingers to grasp at least one of tiles, rocks, leaves, and dirt during cleaning of the pool.

The motor 112d may be disposed within at least a portion of the first glove 112. The power button 112f may be disposed on at least a portion of the first glove 112. Furthermore, the motor 112d may be enclosed in any waterproof material described above. The motor 112d may activate the scrubbing surface 111a, such that the scrubbing surface 112a may rotate and/or vibrate in response to the user pressing the power button 112f. Alternatively, the user may turn on the motor 111d using the external device 10. Moreover, motor 112d receives power from the battery 112e.

The battery 112e may include lithium-ion, nickel cadmium, nickel metal hydride, alkaline, etc., but is not limited thereto. The battery 112e may be disposed within an enclosure constructed from any waterproof material described above. The battery 112e may be removed from the enclosure to be recharged.

Referring to FIG. 2, the pair of cleansing footwear 120 is illustrated to be a pair of shoes. However, the pair of cleansing footwear 120 may be socks, slippers, sandals, etc., but is not limited thereto. The pair of cleansing footwear 120 may be of any predetermined size, such as small, medium, large, and/or one size fits all.

The pair of cleansing footwear 120 may include a first shoe 121 and a second glove 122, but is not limited thereto.

The first shoe 121 may include a scrubbing surface 121a, a foot receiving aperture 121b, a motor 121c, a battery 121d, and a power button 121e, but is not limited thereto.

Referring to FIG. 2, the scrubbing surface 121b is illustrated to be disposed on at least a portion of a bottom surface of the first shoe 121. However, the scrubbing surface 121a may be disposed at any feasible location on the shoe, such as toe portions and at least a portion of a top surface of the first shoe 121.

The scrubbing surface 121a may include a plurality of bristles, a bubbled surface having protrusions extending therefrom, a mesh, and/or a sponge, etc., but is not limited thereto. The bristles may be short, long, hard, and/or soft, etc., but are not limited thereto. The scrubbing surface 121a may be applied against a portion of a surface in the pool needing to be cleansed. Specifically, the scrubbing surface 121a may be used to scrub the surface of the pool to remove settlement, fungus, mildew, mold, and/or dirt, etc., but is not limited thereto.

The foot receiving aperture 121b may receive the user's first foot therein in response to the user inserting the first foot inside the first shoe 121.

The motor 121c may be disposed within at least a portion of the first shoe 121. The power button 121f may be disposed on at least a portion of the first shoe 121. Furthermore, the motor 121c may be enclosed in any waterproof material described above. The motor 121c may activate the scrubbing surface 121a, such that the scrubbing surface 121a may rotate and/or vibrate in response to the user pressing the power button 121e. Alternatively, the user may turn on the motor 121c using the external device 10, such as a mobile device, a computer, tablet, a personal digital assistant (PDA), etc., but is not limited thereto. Moreover, motor 121c receives power from the battery 121d.

The battery 121d may include lithium-ion, nickel cadmium, nickel metal hydride, alkaline, etc., but is not limited thereto. The battery 121d may be disposed within an enclosure constructed from any waterproof material described above. The battery 121d may be removed from the enclosure to be recharged.

The second shoe 122 may include a scrubbing surface 122a, a foot receiving aperture 122b, a motor 122c, a battery 122d, and a power button 122e, but is not limited thereto.

Referring to FIG. 2, the scrubbing surface 122b is illustrated to be disposed on at least a portion of a bottom surface of the second shoe 122. However, the scrubbing surface 122a may be disposed at any feasible location on the shoe, such as toe portions and at least a portion of a top surface of the second shoe 122.

The scrubbing surface 122a may include a plurality of bristles, a bubbled surface having protrusions extending therefrom, a mesh, and/or a sponge, etc., but is not limited thereto. The bristles may be short, long, hard, and/or soft, etc., but are not limited thereto. The scrubbing surface 122a may be applied against a portion of a surface in the pool needing to be cleansed. Specifically, the scrubbing surface 122a may be used to scrub the surface of the pool to remove settlement, fungus, mildew, mold, and/or dirt, etc., but is not limited thereto.

The foot receiving aperture 122b may receive the user's second foot therein in response to the user inserting the second foot inside the second shoe 122.

The motor 122c may be disposed within at least a portion of the second shoe 121. The power button 122f may be disposed on at least a portion of the second shoe 122. Furthermore, the motor 122c may be enclosed in any waterproof material described above. The motor 122c may activate the scrubbing surface 122a, such that the scrubbing surface 121a may rotate and/or vibrate in response to the user pressing the power button 122e. Alternatively, the user may turn on the motor 122c using the external device 10, such as a mobile device, a computer, tablet, a personal digital assistant (PDA), etc., but is not limited thereto. Moreover, motor 122c receives power from the battery 122d.

The battery 122d may include lithium-ion, nickel cadmium, nickel metal hydride, alkaline, etc., but is not limited thereto. The battery 122d may be disposed within an enclosure constructed from any waterproof material described above. The battery 122d may be removed from the enclosure to be recharged.

The use of a conventional brush and/or a pool scrubber may be too tedious for the user to use to clean the pool. The pool cleaning system 100 offers a more efficient means of cleaning the pool. The pool cleaning system 100 may be used while the pool water has been drained or during swimming in the pool. Specifically, the user may apply the pair of cleansing handwear 110 and the pair of cleansing footwear 120 on the tiles in the pool. As such, the user may scrub the tiles to remove settlement, fungus, mildew, mold, and/or dirt, etc., but is not limited thereto. Furthermore, the user may use a vacuum to clean up the particles disturbed from scrubbing.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A pair of cleansing handwear, comprising:
a scrubbing surface to scrub a surface of a pool to remove at least one of settlement, dirt, fungus, mildew, mold, and dirt; and
at least one fingerless portion, such that at least one of a user's fingers can grasp at least one of tiles, rocks, leaves, and dirt during cleaning of the pool.

2. The pair of cleansing handwear of claim 1, wherein the scrubbing surface comprises:
at least one of a plurality of bristles, a bubbled surface having protrusions extending therefrom, a mesh, and a sponge.

3. The pair of cleansing handwear of claim 1, further comprising:
a power button disposed on at least a portion of the pair of cleansing handwear; and
a motor to activate the scrubbing surface, such that the scrubbing surface rotates in response to the user pressing the power button.

4. A pair of cleansing footwear, comprising:
a scrubbing surface to scrub a surface of a pool to remove at least one of settlement, dirt, fungus, mildew, mold, and dirt; and
a foot receiving aperture to receive a user's foot.

5. The pair of cleansing footwear of claim 4, wherein the scrubbing surface comprises:
at least one of a plurality of bristles, a bubbled surface having protrusions extending therefrom, a mesh, and a sponge.

6. The pair of cleansing footwear of claim 4, further comprising:
a power button disposed on at least a portion of the pair of cleansing footwear; and
a motor to activate the scrubbing surface, such that the scrubbing surface rotates in response to the user pressing the power button.

7. A pool cleansing system, comprising:
a pair of cleansing handwear, comprising:
a scrubbing surface to scrub a surface of a pool to remove at least one of settlement, dirt, fungus, mildew, mold, and dirt, and
at least one fingerless portion, such that at least one of a user's fingers can grasp at least one of tiles, rocks, leaves, and dirt during cleaning of the pool; and
a pair of cleansing footwear, comprising:
a scrubbing surface to scrub a surface of a pool to remove at least one of settlement, dirt, fungus, mildew, mold, and dirt, and
a foot receiving aperture to receive a user's foot.
